(19) United States
(12) Patent Application Publication
(10) Pub. No.: US 2004/0193924 A1
(43) Pub. Date: Sep. 30, 2004

(54) Authentication apparatus, authentication method, and computer product

(75) Inventors: Tomoki Kira, Kawasaki (JP); Shintaro Suzuki, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/768,126

(22) Filed: Feb. 2, 2004

(30) Foreign Application Priority Data
Mar. 27, 2003 (JP) 2003-089217

(51) Int. Cl. H04L 9/00; G06F 15/16

(52) U.S. Cl. 713/201; 709/206

(57) ABSTRACT

An authentication apparatus decides whether a sender of an e-mail received is an authentic user. The authentication apparatus includes a confirmation mail transmission unit that transmits a confirmation e-mail to the sender demanding the sender to reply to the confirmation e-mail; and an authentication deciding unit that decides whether the sender is an authentic user depending on whether the sender replies to the confirmation mail.

### BACKGROUND OF THE INVENTION

1) Field of the Invention

The present invention relates to a technology for deciding whether an e-mail received has been transmitted by a sender that is an authentic user, and more specifically, relates to preventing spoofing by a third party.

2) Description of the Related Art

Remote control systems are known that make it possible to remotely control a server in a different network, without requiring a special encryption technique or setting operation by a system administrator. See, for example, Japanese Patent Application Laid-Open No. H10-334002 (P. 4 and P. 5, and FIG. 1). Specifically, a program processor connected to the network as a client receives an e-mail describing a command for executing specific processing, and as a result of investigation, when the processing by the command described in the e-mail is executable, the program processor executes the processing.

In this specification, “investigation” means to investigate whether a sender described in a column of “from” in a sender's e-mail address in the e-mail received by the program processor is a user who is permitted to instruct execution of the processing, based on a table (a table in which a specific user and the processing that the user can instruct are associated with each other and stored beforehand).

However, the conventional art has a problem that it cannot prevent spoofing by the third party. When a destination address is leaked to the third party, it cannot prevent spoofing by the third party who describes the e-mail address of the regular user in the column of “from” in the sender's e-mail address, and transmits the e-mail.

### SUMMARY OF THE INVENTION

It is an object of the present invention to solve at least the problems in the conventional technology.

An authentication apparatus according to the present invention decides whether a sender of an e-mail received is an authentic user. The authentication apparatus includes a confirmation mail transmission unit that transmits a confirmation e-mail to the sender demanding the sender to reply to the confirmation e-mail; and an authentication deciding unit that decides whether the sender is an authentic user depending on whether the sender replies to the confirmation mail.

The other objects, features, and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a block diagram of an authentication apparatus. according to a first embodiment of the present invention;

FIG. 2 is to explain an outline and characteristics of the process performed by the authentication apparatus;

FIGS. 3A to 3C are examples of e-mails;

FIG. 4 is a flowchart of authentication processing;

FIG. 5 is a flowchart of command processing;

FIGS. 6A to 6C are examples of e-mails;

FIG. 7 is a schematic of a computer system according to a second embodiment of the present invention; and

FIG. 8 is a detailed block diagram of a main unit of the computer system.

### DETAILED DESCRIPTION

Exemplary embodiments of an authentication apparatus, an authentication method, and a computer program according to the present invention will be described in detail below with reference to the accompanying drawings. Although not limited, for the sake of explanation, the present invention is applied to a server in a network system having a security control unit such as a firewall.

An authentication apparatus and an authentication method according to a first embodiment will be explained first, then a computer system that executes an authentication program according to the second embodiment, and lastly, various modification examples as other embodiments.

In a first embodiment, the authentication apparatus (authentication method) that authenticates whether an e-mail describing a command character string has been transmitted from a regular user, and when it is authenticated that the e-mail has been transmitted from the regular user, executes the processing by the command described in the e-mail, will be explained. After the outline and a main feature of the authentication apparatus according to the first embodiment are explained, the configuration of the authentication apparatus and then the procedure of various processing by the authentication apparatus will be explained.

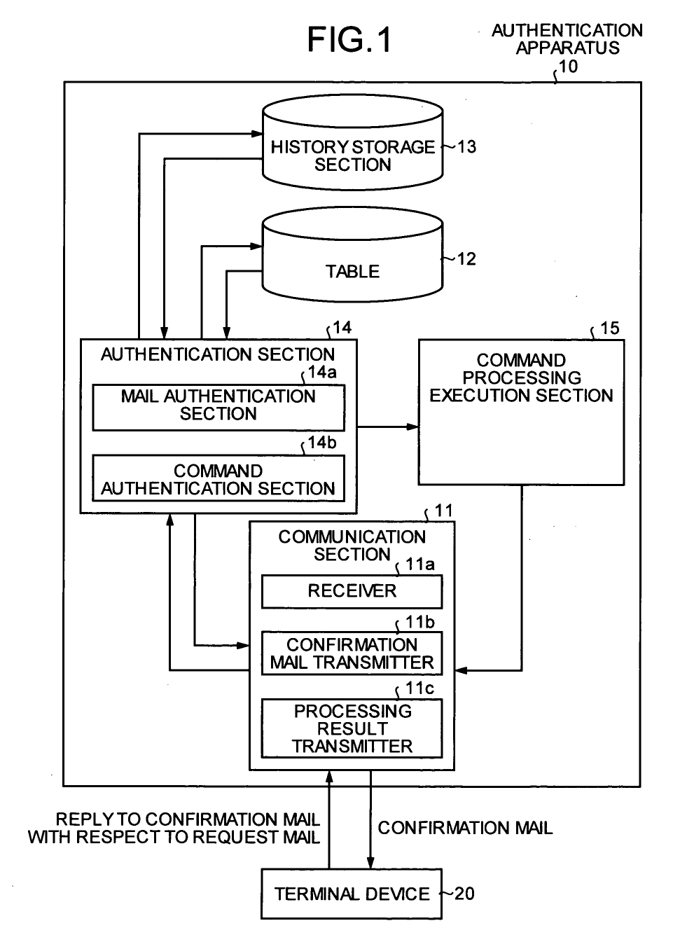

The outline and the main feature of the authentication apparatus according to the first embodiment will be explained first. FIG. 1 is a block diagram of an authentication apparatus according to the first embodiment of the present invention. An authentication apparatus 10 shown in FIG. 1 authenticates whether an e-mail describing a command character string has been transmitted by a regular user, and when it is authenticated that the e-mail has been transmitted by the regular user, the authentication apparatus executes the processing by the command described in the e-mail.

The authentication apparatus according to the embodiment has a main feature in the authentication processing in which a confirmation mail demanding a reply to the e-mail is transmitted to a sender of the e-mail, to authenticate whether the e-mail has been transmitted by the regular user, according to the presence of a reply to the confirmation mail. By such authentication processing, the authentication apparatus can prevent spoofing by the third party.

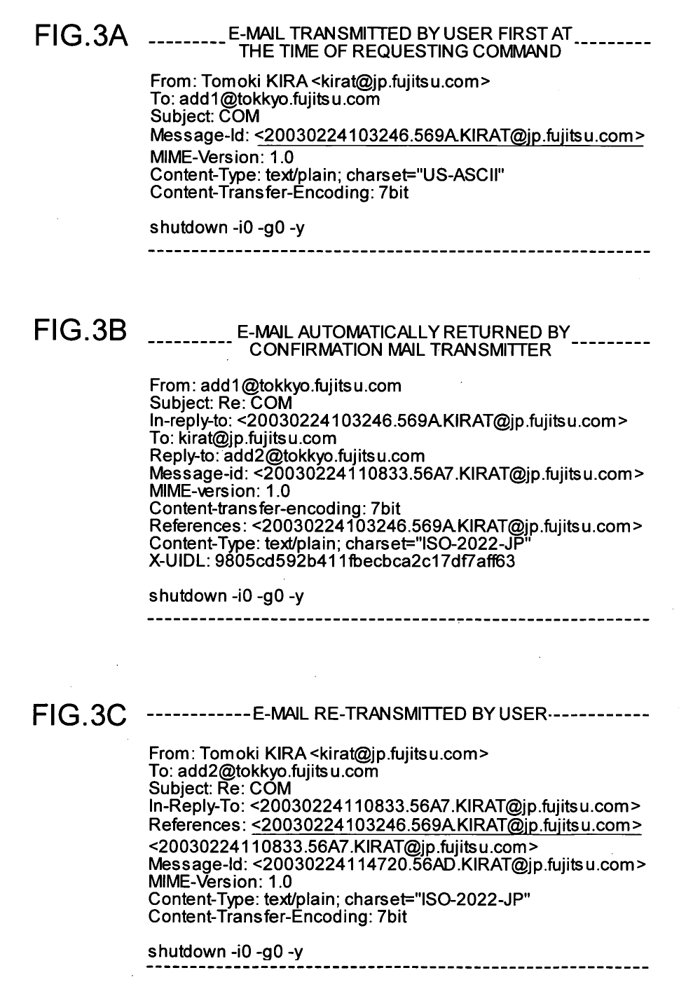

The main feature of the authentication apparatus is explained specifically. That is, even if the third party tries to spoof as a regular user, by describing an e-mail address of the regular user in the column of “from” in the sender's e-mail address and transmitting the e-mail, since the confirmation mail (the confirmation mail demanding a reply to the mail) transmitted by the authentication apparatus 10 is transmitted to the regular user, the third party cannot reply to the confirmation mail transmitted from the authentication apparatus 10. Therefore, when there is a reply to the confirmation mail, the authentication apparatus can authenticate the e-mail as the one transmitted by the regular user. Further, even if the third party can reply to the confirmation mail, since the authentication apparatus 10 performs authentication by comparing a “message-ID” in the first received e-mail with a “References” tag in the reply mail with respect to the confirmation mail, the authentication apparatus 10 can reliably eliminate spoofing by the third party (see FIGS. 3A and 3C).

Therefore, in the example of the conventional art, the authentication apparatus authenticates the regular user, not by comparing only the column of “from” in the sender's e-mail address with the table (the table in which a specific user and the processing that the user can instruct are associated with each other and stored beforehand), but by transmitting a confirmation mail demanding a reply to the confirmation mail with respect to the sender of the e-mail, and authenticating whether the e-mail has been transmitted by the regular user according to the presence of a reply to the confirmation mail. As a result, the authentication apparatus can prevent spoofing by the third party as in the main feature.

The e-mail address for receiving a reply to the confirmation mail is an e-mail address for confirmation, different from the e-mail address for receiving the e-mail, and when the reply to the confirmation mail is received by the e-mail address for confirmation, the e-mail is authenticated as the one transmitted by the regular user. In other words, only the regular user can properly send the reply mail to the confirmation mail, and hence the authentication apparatus can reliably prevent spoofing by the third party.

The e-mail is for describing a character string of a command, and when the e-mail is authenticated as the one transmitted by the regular user, the authentication apparatus executes the processing by the command described in the e-mail. As a result, the authentication apparatus can execute the processing by the command, while preventing spoofing by the third party.

The command processing is executed by a processing system independent of that for the authentication processing. As a result, hacking by the third party can be prevented, by separating the execution right for the authentication processing from the execution right for the command processing, and concealing the execution right for the command processing.

When the e-mail is authenticated as the one transmitted by the regular user, the authentication apparatus stores the history of the e-mail, accepts a selection of a predetermined e-mail from the history of e-mails, and executes the processing by the command described in the accepted predetermined e-mail. As a result, the time and energy for re-inputting the command issued in the past can be saved, thereby enabling efficient execution of the command processing.

The result of the command processing is transmitted to the sender of the e-mail. As a result, the regular user can obtain the result of the command processing.

The authentication apparatus 10 includes a communication section 11, a table 12, a history storage section 13, an authentication section 14, and a command processing execution section 15.

The communication section 11 is a control unit that controls communication relating to various kinds of information between an internal or external communication device (for example, a known personal computer, a workstation, a server device, a Personal Handyphone System (PHS) terminal, a portable terminal, a mobile communication terminal, or an information processor such as Personal Digital Assistant (PDA)) and the authentication apparatus, and functionally includes a receiver 11a, a confirmation mail transmitter 11b, and a processing result transmitter 11c.

The receiver 11a is a processor that receives various kinds of information from a terminal device 20. Specifically, the receiver 11a includes two separate addresses, that is, an e-mail address 1 for receiving a request mail for the command processing, and a confirmation mail address (an e-mail address for receiving a reply mail with respect to the confirmation mail) 2, in order to reinforce prevention of spoofing by the third party. The function of receiving the request mail for command processing, and a function of receiving a reply with respect to the confirmation mail, given to the e-mail address 1 and the e-mail address 2, can be optionally changed.

The confirmation mail transmitter 11b is a processor that transmits the confirmation mail demanding a reply to the e-mail with respect to the sender of the e-mail. Specifically, the confirmation mail transmitter 11b transmits the confirmation mail, designating the e-mail address for receiving the reply to the confirmation mail as a sender.

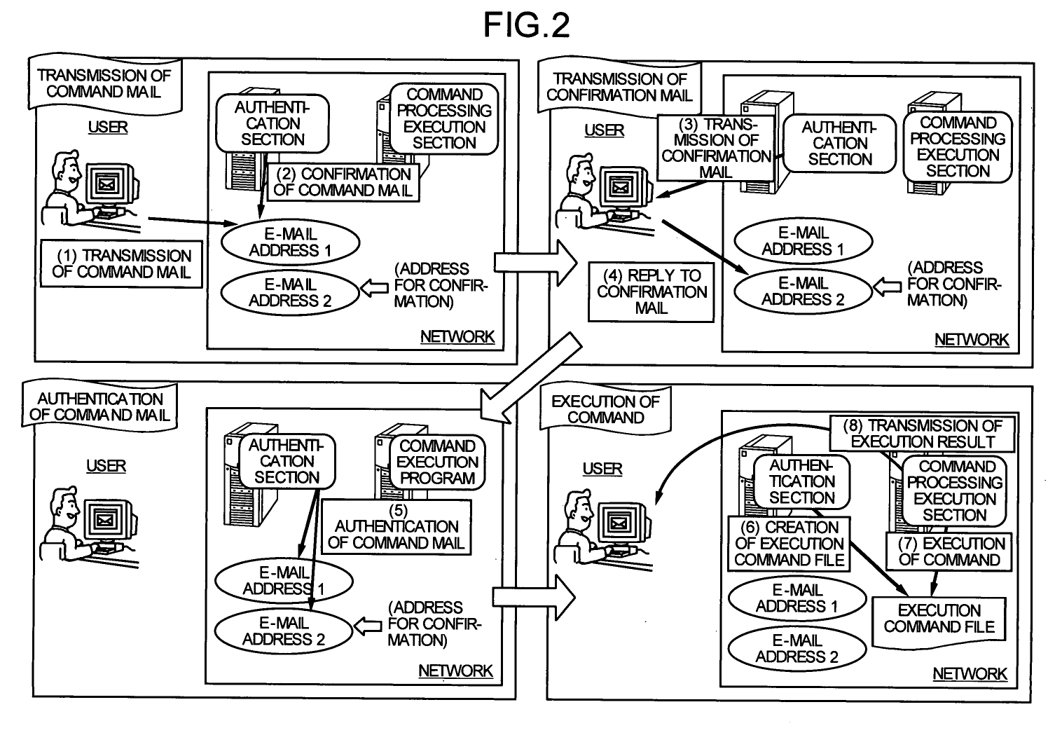

That is, when a request mail for the command processing is received by the e-mail address 1, the confirmation mail transmitter 11b changes “Reply-To” (the e-mail address at the time of replying to the mail) in the confirmation mail to the e-mail address 2, and transmits the confirmation mail to the terminal device 20. Only the regular user can properly send a reply mail to the confirmation mail, by controlling so that a reply to the confirmation mail is sent to a confirmation mail address (mail address 2) different from the e-mail address (mail address 1) for receiving a request for the command processing. As a result, spoofing by the third party can be reliably prevented (see FIGS. 2 and 3A to 3C).

The processing result transmitter 11c is a processor that transmits the result of the command processing executed by the command processing execution section 15 to the sender of the e-mail. Specifically, the processing result transmitter 11c transmits a log of the command processing result (particularly, processing result of an information output system command such as “Is” or “df”) to the terminal device 20.

The table 12 is a memory in which a specific user (the regular user) and the processing that the user can request are associated with each other and stored beforehand.

The history storage section 13 is a processor that stores the history of the e-mail, when the e-mail is authenticated as the one transmitted by the regular user by the mail authentication section 14a. Specifically, the history storage section 13 refers to the “message-ID” of the first received mail and the “References” tag of the reply mail to the confirmation mail, to control the history of the e-mail, in order to save time and energy for re-inputting the command issued in the past (a command generally used or a command whose input is complicated).

Schematically, the authentication section 14 is a processor that performs mail authentication for authenticating whether an e-mail received by the receiver 11a has been transmitted by a regular user, and command authentication for authenticating a character string of a command described in the e-mail, and functionally includes a mail authentication section 14a, and a command authentication section 14b.

The mail authentication section 14a is a processor that authenticates whether the e-mail has been transmitted by the regular user, according to the presence of a reply to the confirmation mail transmitted by the confirmation mail transmitter 11b. That is, since the e-mail address of the regular user is described in the mail received by the receiver 11a, the confirmation mail (confirmation mail demanding a reply to the mail) transmitted by the confirmation mail transmitter 11b is transmitted to the regular user. Therefore, the third party cannot reply to the confirmation mail transmitted by the confirmation mail transmitter 11b. As a result, when there is a reply to the confirmation mail, the mail authentication section 14a can authenticate that the e-mail has been transmitted by the regular user (see FIG. 2).

The mail authentication section 14a performs authentication by comparing the e-mail first received by the receiver 11a with the header information (“message-ID” of the first received e-mail and the “References” tag of the reply mail to the confirmation mail) of the reply mail to the confirmation mail transmitted by the confirmation mail transmitter 11b. In other words, even if the third party tries to imitate a reply to the confirmation mail, since the third party cannot make the first received e-mail agree with the header information of the reply mail to the confirmation mail, spoofing by the third party can be reliably eliminated (see FIGS. 3A and 3C).

The command authentication section 14b is a processor that authenticates the command character string described in the e-mail, when the mail authentication section 14a authenticates the e-mail as the one transmitted by the regular user. The command authentication section 14b cuts out the command character string described in the e-mail to create an “execution command file”.

The command processing execution section 15 is a processor that executes the processing by the command described in the e-mail, when the mail authentication section 14a authenticates the e-mail as the one transmitted by the regular user. Specifically, the command processing execution section 15 reads out the “execution command file” created by the command authentication section 14b, and executes the processing by the command. According to the embodiment, since the command processing is executed by the processing system independent of that for the authentication processing, hacking by the third party can be prevented, by separating the execution right for the authentication processing from that for the command processing, and concealing the execution right for the command processing.

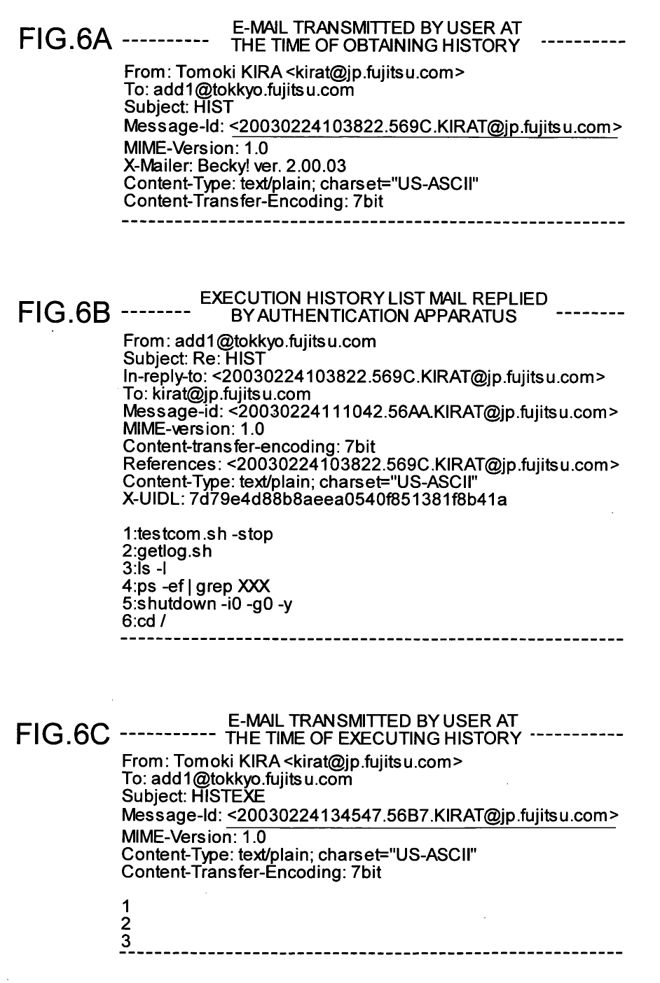

The command processing execution section 15 accepts a selection of a predetermined e-mail from the history of e-mails stored by the history storage section 13 and executes the processing by the command described in the accepted predetermined e-mail. Specifically, when having received a request mail for the past history list (an e-mail describing a character string “HIST” for obtaining the history in the column of “Subject” (see FIG. 6A)) from the regular user, the command processing execution section 15 refers to the history storage section 13, to transmit a history list mail (see FIG. 6B) describing the past command and the command ID. The command processing execution section 15 then receives a history execution mail (an e-mail describing a character string “HISTEXE” for history execution in the column of “Subject” (see FIG. 6C)) as a reply to the history list mail, and executes the processing by the command corresponding to the command ID described in the received history execution mail. As a result, the time and energy for re-inputting the command issued in the past can be saved, thereby enabling efficient execution of the command processing.

Procedures in various types of processing by the authentication apparatus 10 according to the first embodiment will be explained below. The authentication processing (1) for authenticating whether the received e-mail has been transmitted by a regular user is first explained, and then the “command processing” (2) for executing the processing by the command described in the e-mail by a processing system independent of the authentication processing will be explained.

(1) Authentication Processing

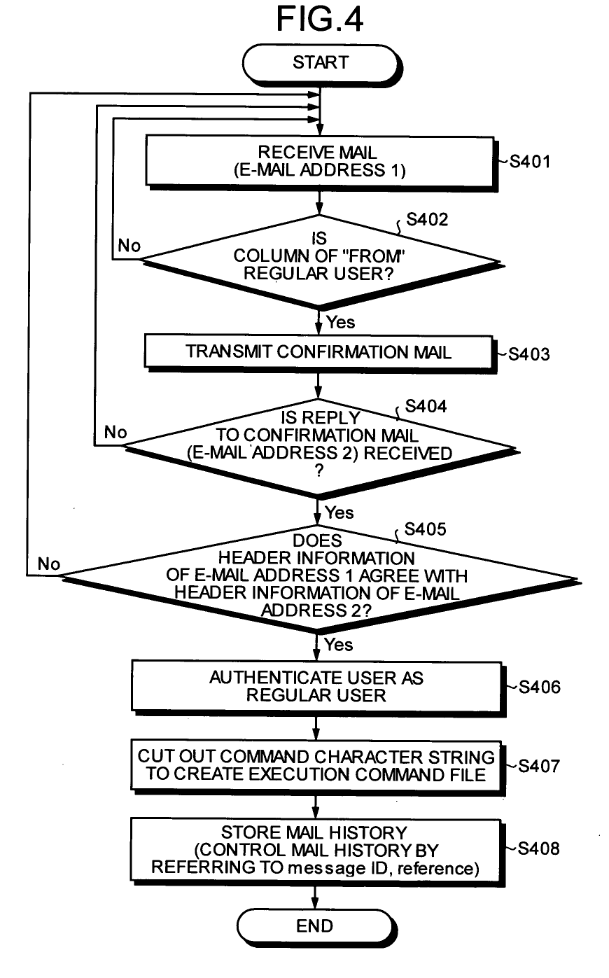

FIG. 4 is a flowchart illustrating the procedure in the authentication processing. As shown in this figure, the receiver 11a receives a request mail (see FIG. 3A) for the command processing by an e-mail address 1 (step S401). Subsequently, the mail authentication section 14a authenticates whether the e-mail received by the receiver 11a has been transmitted by the regular user, based on the table 12 (step S402).

When the e-mail is authenticated as the one transmitted by the regular user (Yes, at step S402), the confirmation mail transmitter 11b transmits a confirmation mail demanding a reply to the mail with respect to the sender of the e-mail, (step S403). Specifically, the confirmation mail transmitter 11b changes “Reply-To” in the confirmation mail (address for replying to the mail) to the e-mail address 2, and transmits the confirmation mail (see FIG. 3B) to the terminal device 20.

When there is a reply to the confirmation mail transmitted by the confirmation mail transmitter 11b (Yes, at step S404), and the header information of the e-mail received by the e-mail address 1 and the header information of the e-mail received by the e-mail address 2 agree with each other (see FIGS. 2, 3A, and 3C) (Yes, at step S405), the mail authentication section 14a authenticates the e-mail as the one transmitted by the regular user (step S406).

The command authentication section 14b cuts out the command character string described in the e-mail to create the “execution command file” (step S407). The history storage section 13 stores the history of the e-mail (step S408). Specifically, the history storage section 13 refers to the “massage-ID” in the first received mail and the “References” tag in the reply mail with respect to the confirmation mail, and stores and controls the history of the e-mail.

The authentication apparatus according to the first embodiment authenticates whether an e-mail has been transmitted by a regular user according to the presence of a reply to the confirmation mail transmitted by the confirmation mail transmitter 11b. As a result, spoofing by the third party can be prevented.

According to the authentication apparatus in the first embodiment, the e-mail address for receiving the reply to the confirmation mail is an e-mail address for confirmation, different from the e-mail address for receiving the e-mail, and when having received a reply to the confirmation mail by the e-mail address for confirmation, the authentication apparatus authenticates the e-mail as the one transmitted by the regular user. As a result, only the regular user can properly send a reply mail to the confirmation mail, thereby enabling reliable prevention of spoofing by the third party.

(2) Command Processing

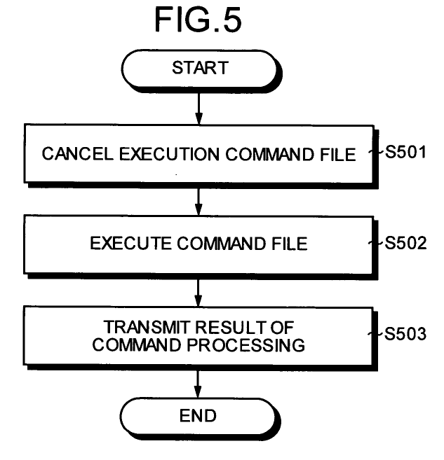

The command processing will be explained. FIG. 5 is a flowchart illustrating the procedure for the command processing. As shown in FIG. 5, the command execution processor 15 reads the “execution command file” created by the command authentication section 14b (step S501), and executes the processing by the command (step S502).

The processing result transmitter 11c transmits the result of the processing by the command executed by the command processing execution section 15 to the sender of the e-mail (step S503). Specifically, the processing result transmitter 11c transmits the log of the command processing result (particularly, the processing result of the information output system command such as “Is” or “df”) to the terminal device 20.

According to the authentication apparatus in the first embodiment, the e-mail is for describing a command character string, and when the e-mail is authenticated as the one transmitted by the regular user, the processing by the command described in the e-mail is executed. As a result, the authentication apparatus can execute the processing by the command described in the e-mail, while preventing spoofing by the third party.

According to the authentication apparatus in the first embodiment, since the command processing is executed by the processing system independent of that for the authentication processing, the execution right for the authentication processing can be separated from the execution right for the command processing, and the execution right for the command processing can be concealed. As a result, hacking by the third party can be prevented.

According to the authentication apparatus in the first embodiment, since the result of the command processing is transmitted to the sender of the e-mail, the regular user can obtain the result of the command processing.

The authentication apparatus and the authentication method explained in the first embodiment can be realized by executing a program prepared beforehand by a computer system such as a personal computer and a workstation. In a second embodiment of the present invention, the computer system that executes the authentication program having the same function as that of the authentication apparatus (authentication method) explained in the first embodiment will be explained.

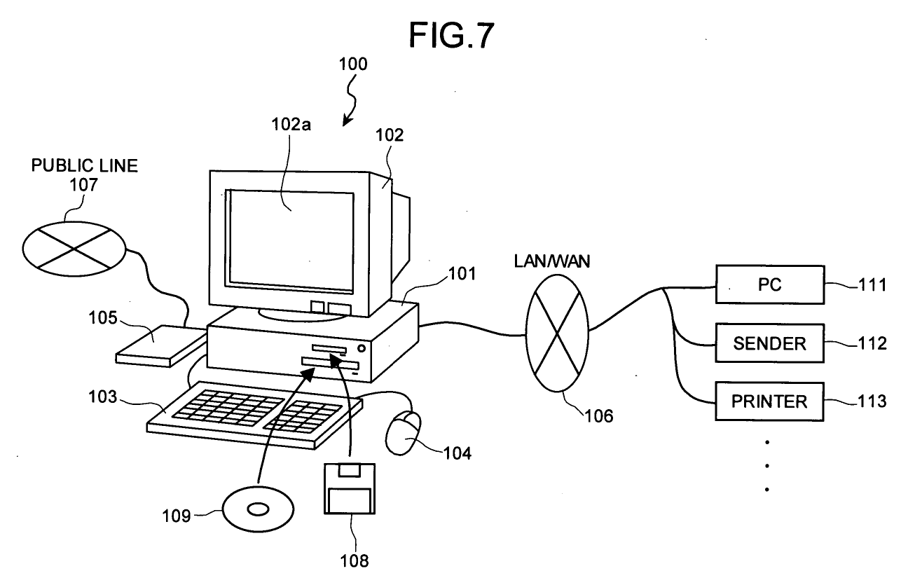

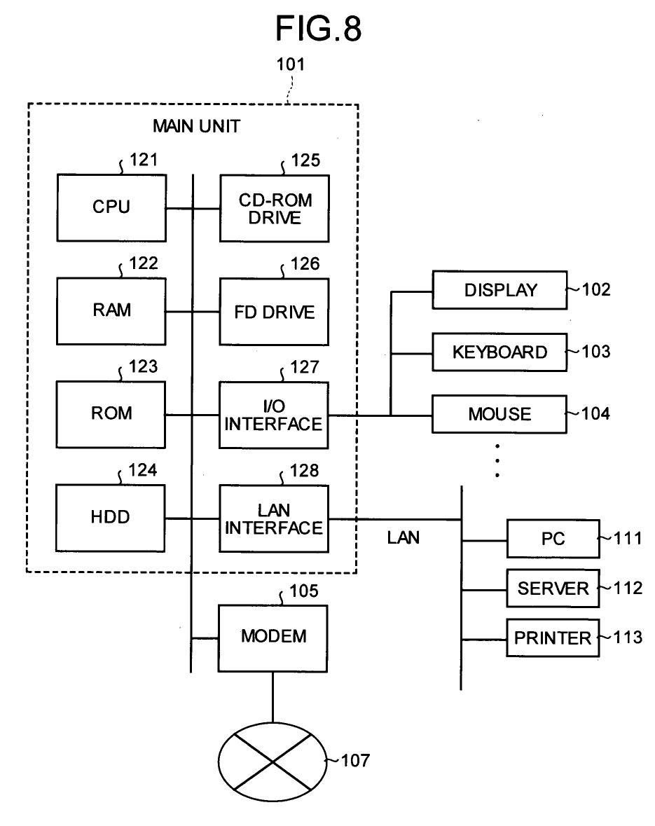

FIG. 7 is a schematic of a computer system according to the second embodiment, and FIG. 8 is a detailed block diagram of the main unit of the computer system. As shown in FIG. 7, the computer system 100 includes a body 101, a display 102 for displaying information such as images on a display screen 102a according to the instruction from the body 101, a keyboard 103 for inputting various kinds of information to the computer system 100, and a mouse 104 for specifying an optional position on the display screen 102a of the display 102.

As shown in FIG. 8, the body 101 in the computer system 100 includes a Central Processing Unit (hereinafter, “CPU”) 121, a Random Access Memory (hereinafter, “RAM”) 122, a Read Only Memory (hereinafter, “ROM”) 123, a hard disc drive (hereinafter, “HDD”) 124, a CD-ROM drive 125 for accepting a CD-ROM 109, a flexible disc (hereinafter, “FD”) drive 126 for accepting a FD 108, an I/O interface 127 for connecting the display 102, the keyboard 103, and the mouse 104 with each other, and a Local Area Network (hereinafter, “LAN”) interface 128 for connecting to a Local Area Network or Wide Area Network (hereinafter, “LAN/WAN”) 106.

Further, the computer system 100 is connected with a modem 105 for connecting to a public line 107 such as the Internet, and is also connected with another computer system (Personal Computer (PC)) 111, the server 112, and the printer 113 via a LAN interface 128, and the LAN/WAN 106.

The computer system 100 realizes the authentication apparatus (authentication method) by reading and executing the authentication program recorded in a predetermined recording medium. Examples of the predetermined recording medium include various types of recording mediums that store the authentication program that can be read by the computer system 100, for example, “portable physical mediums” such as the flexible disk (FD) 108, the CD-ROM 109, a Magneto Optical disk (MO), a Digital Versatile Disk (DVD), and an IC card, “fixed physical mediums” such as the hard disk drive (HDD) 124 included in or out of the computer system 100, the RAM 122, and the ROM 123, and “communication mediums” for holding the program for a short period of time when the program is transmitted through a network represented by the public line 107 connected via the modem 105, and the LAN/WAN 106 connected with the other computer system 111 and the server 112.

In other words, the authentication program is stored in a computer readable manner in the recording medium such as the “portable physical mediums”, the “fixed physical mediums”, and the “communication mediums”, and the computer system 100 realizes the authentication apparatus and the authentication method by reading the authentication program from the recording medium and executing the program. The authentication program can be executed not only by the computer system 100, but also when the other computer system 111 or the server 112 executes the authentication program, or when these cooperate to execute the authentication program, the present invention is applicable likewise.

The exemplary embodiments of the present invention have been explained above, however, the present invention may be executed in various different embodiments within the scope of the technical idea described in the scope of claims, other than the described embodiments.

For example, in the present invention, the confirmation mail is transmitted to the sender of the e-mail as well as another previously registered user, and when there is a reply to the confirmation mail from both of the sender of the e-mail and the other previously registered user, the e-mail is authenticated as the one transmitted by the regular user. For example, the confirmation mail is transmitted to the sender of the e-mail and an administrator, and when there is a reply to the confirmation mail from both of the sender of the e-mail and the administrator (approval mail for executing the processing), the execution of the command processing is permitted, thereby enabling versatile prevention of spoofing by the third party.

Furthermore, data on the screen is transmitted to the sender of the e-mail, as the result of the command processing. In other words, since a hard copy of the screen of the authentication apparatus after executing the command is made, and attached to the e-mail and transmitted, it can be confirmed whether there has been any trouble in the process of command processing.

An example has been explained so far in which the authentication apparatus, the authentication method, and the computer program according to the present invention is applied to the server in the network system having a security control unit, such as firewall. However, the present invention is not limited thereto, and the present invention is also applicable to the “authentication processing” relating to e-mails performed via a network such as a public telephone network or the Internet (for example, authentication processing for authenticating whether a regular user has placed an order in an Internet shop).

Of the respective processing explained in the embodiments, the whole or a part of the processing explained as being performed automatically may be manually performed, or the whole or a part of the processing explained as being performed manually may be performed automatically by a known method. The information including the processing procedure, the control procedure, specific names, and various data and parameters described and shown in the specification and the drawings may be optionally changed, unless otherwise specified.

The respective components in the illustrated respective devices are functional and conceptual, and need not be constructed physically as illustrated. In other words, the specific form of distribution and integration of the respective devices is not limited to the one shown in the figure, and the whole or a part thereof may be distributed or integrated functionally or physically in an optional unit, according to various loads or status of use. Further, the whole or a part of the respective processing functions executed by the respective devices may be realized by a CPU or a program analyzed and executed by the CPU, or may be realized as hardware by the wired logic.

As explained above, according to the present invention, it is possible to prevent reliably the spoofing of the third party.

According to the present invention, the e-mail is for describing a character string of a command, and when the e-mail is authenticated as the one transmitted by the regular user, the processing by the command described in the e-mail is executed. As a result, there is the effect that the authentication apparatus that can execute command processing, while preventing spoofing of the third party can be obtained.

According to the present invention, since the command processing is executed by a processing system independent of the processing system for the authentication processing, the execution right for the authentication processing can be separated from the execution right for the command processing, and the execution right for the command processing can be concealed. As a result, there is the effect that an authentication apparatus that can prevent hacking by the third party can be obtained.

According to the present invention, when the e-mail is authenticated as the one transmitted by the regular user, the authentication apparatus stores the history of the e-mail, accepts a selection of a predetermined e-mail from the history of e-mails, and executes the processing by the command described in the accepted predetermined e-mail. As a result, there is the effect that an authentication apparatus that can save the time and energy for re-inputting the command issued in the past, thereby enabling efficient execution of the command processing can be obtained.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An authentication apparatus that decides whether a sender of an e-mail received is an authentic user, comprising:
a confirmation mail transmission unit that transmits a confirmation e-mail to the sender demanding the sender to reply to the confirmation e-mail; and
an authentication deciding unit that decides whether the sender is an authentic user depending on whether the sender replies to the confirmation mail.

2. The authentication apparatus according to claim 1, wherein
the confirmation mail transmission unit transmits the confirmation mail also to a previously registered user, as well as the sender, and
the authentication deciding unit that decides that the sender is an authentic user when there is a reply to the confirmation mail from both of the sender and the previously registered user.

3. The authentication apparatus according to claim 1, wherein
the e-mail address for receiving the reply to the confirmation mail is an e-mail address for confirmation, different from the e-mail address for receiving the e-mail, and
when the reply to the confirmation mail is received by the e-mail address for confirmation, the authentication deciding unit authenticates the e-mail as the one transmitted by the regular user.

4. The authentication apparatus according to claim 3, wherein the confirmation mail transmission unit controls so as to transmit the confirmation mail, designating the e-mail address for receiving the reply to the confirmation mail as the sender.

5. The authentication apparatus according to claim 1, wherein the e-mail includes a character string of a command, and
the authentication apparatus further comprises a command processing execution unit that executes processing by the command described in the e-mail, when the authentication deciding unit decides that the sender is an authentic user.

6. The authentication apparatus according to claim 5, wherein the command processing execution unit executes the command processing by a processing system independent of the processing system for the authentication processing performed by the authentication deciding unit.

7. The authentication apparatus according to claim 5, further comprising a history storage unit that stores the history of the e-mail, when the authentication deciding unit authenticates the e-mail as the one transmitted by the regular user, wherein
the command processing execution unit accepts a selection of a predetermined e-mail from the history of e-mails stored by the history storage unit, and executes the processing by the command described in the accepted predetermined e-mail.

8. The authentication apparatus according to claim 5, further comprising a processing result transmission unit that transmits the result of the command processing executed by the command processing execution unit to the sender of the e-mail.

9. The authentication apparatus according to claim 5, wherein the processing result transmission unit transmits the data on a screen to the sender of the e-mail, as the result of command processing.

10. An authentication method for deciding whether a sender of an e-mail received is an authentic user, comprising:
transmitting a confirmation e-mail to the sender demanding the sender to reply to the confirmation e-mail; and
deciding whether the sender is an authentic user depending on whether the sender replies to the confirmation mail.

11. The authentication method according to claim 10, wherein the e-mail includes a character string of a command, and
the authentication method further comprises executing processing by the command described in the e-mail, when it is decided at the deciding that the sender is an authentic user.

12. A computer program for realizing on a computer deciding whether a sender of an e-mail received is an authentic user, the computer program making the computer execute:
transmitting a confirmation e-mail to the sender demanding the sender to reply to the confirmation e-mail; and
deciding whether the sender is an authentic user depending on whether the sender replies to the confirmation mail.

13. The computer program according to claim 12, wherein the e-mail includes a character string of a command, and
the computer program further makes the computer execute processing by the command described in the e-mail, when it is decided at the deciding that the sender is an authentic user.
